(19) United States
(12) Patent Application Publication
(10) Pub. No.: US 2021/0304293 A1
(43) Pub. Date: Sep. 30, 2021

(54) MERCHANDISE INFORMATION DISPLAY SYSTEM, STORE SERVER, AND DISPLAY CONTROL METHOD

(71) Applicant: TOSHIBA TEC KABUSHIKI KAISHA, Tokyo (JP)

(72) Inventor: Yusuke NAGATOMO, Shinagawa Tokyo (JP)

(73) Assignee: TOSHIBA TEC KABUSHIKI KAISHA, Tokyo (JP)

(21) Appl. No.: 17/345,816

(22) Filed: Jun. 11, 2021

Related U.S. Application Data
(63) Continuation of application No. 16/919,724, filed on Jul. 2, 2020.

(30) Foreign Application Priority Data
Sep. 20, 2019 (JP) 2019-171397

(51) Int. Cl. G06Q 30/06; G06Q 10/08; G06F 16/9538

(52) U.S. Cl. CPC G06Q 30/0641; G06Q 30/0633; G06Q 30/0639; G06F 16/9538; G06Q 10/087

(57) ABSTRACT

A merchandise information display system includes a store server, an information terminal, and a first storage unit. The store server is configured to manage a merchandise database that stores merchandise information on each merchandise item available in a store. The information terminal includes a communication unit configured to communicate with an external device and a display unit configured to display information and is capable of being carried by a shopper in the store. The first storage unit is configured to store purchase-planned item information indicating an item of merchandise that the shopper wants to purchase. The store server is configured to acquire the purchase-planned item information from the first storage unit when information can be exchanged with the information terminal. The store server is configured to search the merchandise database based on the purchase-planned item information and to check the stock of an item of merchandise that the shopper wants to purchase. The store server is configured to transmit stock information including the stock availability of the item of merchandise that the shopper wants to purchase is in stock to the information terminal and to display the stock information on the display unit of the information terminal.

### CROSS-REFERENCE TO RELATED APPLICATIONS

This application is a continuation of U.S. application Ser. No. 16/919,724 filed Jul. 2, 2020, which is based upon and claims the benefit of priority from Japanese Patent Application No. 2019-171397, filed in Sep. 20, 2019, the entire contents of each of which are incorporated herein by reference.

### FIELD

Embodiments of the present invention relate to a merchandise information display system, a store server, and a display control method.

### BACKGROUND

Many among the shoppers who plan to purchase a large number of merchandise items prepare a memo with a merchandise name and an item name on a piece of paper and purchase merchandise in a store while checking the merchandise written in the memo to not omit the merchandise to plan to purchase. In some cases, a shopping list function for pre-recording merchandise to be purchased is used as a memo by using a shopping support program, which is one of the application programs installed in an information terminal owned by the shopper himself or herself.

On the other hand, in a store, the merchandise that a shopper wants to purchase may be out of stock, or the merchandise itself may not be handled in a store. The shopper does not know whether the merchandise is in the store, and therefore he or she searches around the store looking for such merchandise out of stock or not handled in that store. Examples of related art include JP-A-2013-37428.

### DESCRIPTION OF THE DRAWINGS

FIG. 1 is a block diagram illustrating an overall arrangement of a merchandise information display system according to a first embodiment;

FIG. 2 is a block diagram illustrating a main circuit arrangement of a customer server in FIG. 1;

FIG. 3 is a schematic diagram illustrating a main data structure of a merchandise data record stored in a merchandise database in the customer server;

FIG. 4 is a schematic diagram illustrating a main data structure of a member data record stored in a member database in the customer server;

FIG. 5 is a block diagram illustrating a main circuit configuration of an information terminal in FIG. 1;

FIG. 6 is a schematic diagram illustrating a main data structure of a shopping list storage unit in the information terminal;

FIG. 7 is a flowchart illustrating a procedure of main information processing executed by a processor of the information terminal;

FIG. 8 is a schematic diagram illustrating an example of a shopping list creation screen displayed on a touch panel of the information terminal;

FIG. 9 is a flow chart illustrating a procedure of main information processing executed by a processor of a store server;

FIG. 10 is a schematic diagram illustrating an example of a selection screen displayed on the touch panel of the information terminal;

FIG. 11 is a schematic diagram illustrating an example of a merchandise information screen displayed on the touch panel of the information terminal;

FIG. 12 is a schematic diagram illustrating an example of an alert screen displayed as a pop-up on the merchandise information screen;

FIG. 13 is a flowchart illustrating a procedure of main information processing executed by a processor of an information terminal in a merchandise information display system according to a second embodiment;

FIG. 14 is a flowchart illustrating a procedure of main information processing executed by a processor of a store server;

FIG. 15 is a flowchart illustrating apart of a procedure of main information processing executed by a processor of an information terminal in a merchandise information display system according to a third embodiment;

FIG. 16 is a flowchart illustrating apart of a procedure of main information processing executed by a processor of an information terminal in a merchandise information display system according to a fourth embodiment;

FIG. 17 is a flowchart illustrating apart of a procedure of main information processing executed by a processor of a store server;

FIG. 18 is a block diagram illustrating an overall arrangement of a merchandise information display system according to a fifth embodiment;

FIG. 19 is a block diagram illustrating a main circuit arrangement of a cart controller in FIG. 18; and

FIG. 20 is a block diagram illustrating a main circuit arrangement of a cart information terminal.

### DETAILED DESCRIPTION

A problem to be solved by at least one embodiment of the present invention is to provide a merchandise information display system, a store server, and a display control method that can notify a shopper of the availability of merchandise that the shopper wants to purchase.

In at least one embodiment, a merchandise information display system includes a store server, an information terminal, and a first storage unit. The store server is configured to manage a merchandise database that stores merchandise information on each merchandise item available in a store. The information terminal includes a communication unit configured to communicate with an external device and a display unit configured to display information and is capable of being carried by a shopper in the store. The first storage unit stores purchase-planned item information indicating an item of merchandise that the shopper wants to purchase. The store server is configured to acquire the purchase-planned item information from the first storage unit when information can be exchanged with the information terminal. The store server is configured to search the merchandise database based on the purchase-planned item information and to check the stock of an item of merchandise that the shopper wants to purchase. The store server is configured to transmit stock information including the stock availability of the item of merchandise that the shopper wants to purchase is in stock to the information terminal and to display the stock information on the display unit of the information terminal.

Hereinafter, embodiments will be described with reference to drawings.

### First Embodiment

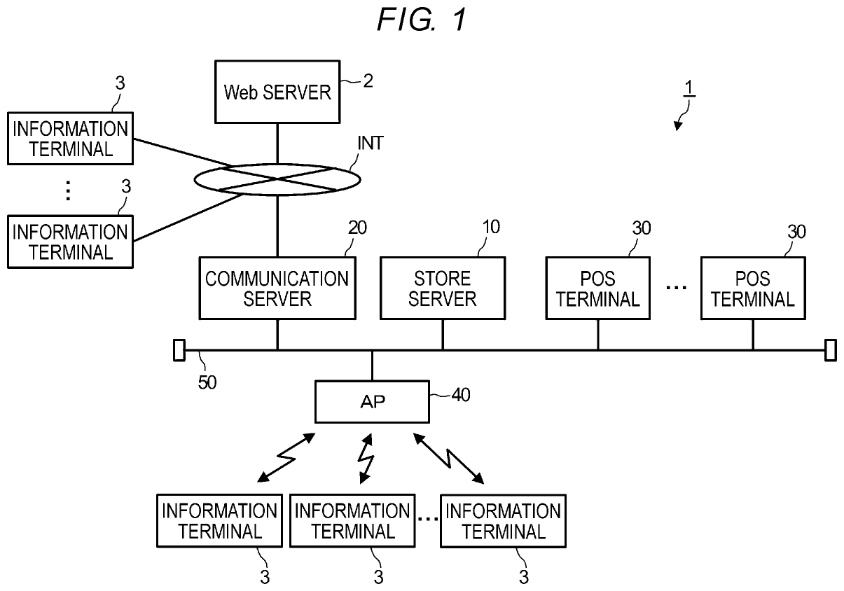

FIG. 1 is a block diagram illustrating an overall at least one of a merchandise information display system according to a first embodiment. The merchandise information display system includes a store system 1, a Web server 2, and an information terminal 3. The store system 1, Web server 2, and information terminal 3 can exchange information via a network INT such as the Internet.

The store system 1 includes a store server 10, a communication server 20, a plurality of point of sales (POS) terminals 30, and an access point (illustrated as AP in FIG. 1) 40. The store server 10, communication server 20, POS terminal 30, and access point 40 are connected to a network 50 such as a local area network (LAN).

The information terminal 3 is an information processing device such as a smartphone or a tablet owned by the shopper. The shopper carries the information terminal 3 when visiting the store where the store system 1 is configured and purchases merchandise. The information terminal 3 includes a wireless unit. The information terminal 3 performs wireless communication with the access point 40. The access point 40 relays communication between the store server 10 connected to the network 50 and the information terminal 3. Although only one access point 40 is illustrated in FIG. 1, there may be two or more access points depending on the scale of the store and the like.

The POS terminal 30 is disposed at a face-to-face cash register where a cashier as a clerk in charge of checkout performs registration and settlement of purchased merchandise. The facing cash register has a scanner. The scanner may be stationary or hand-held. The cashier registers the sales data of the purchased merchandise in the POS terminal 30 by scanning the barcode of the purchased merchandise items one by one with the scanner. The POS terminal 30 calculates the settlement amount of the registered purchased merchandise. The shopper pays the cashier the price corresponding to the amount to be settled. The price can be paid by cash, a credit card, electronic money, points, cash vouchers such as gift certificates, and the like. The POS terminal 30 is an example of a merchandise sales processing device that processes registration and checkout of purchased merchandise.

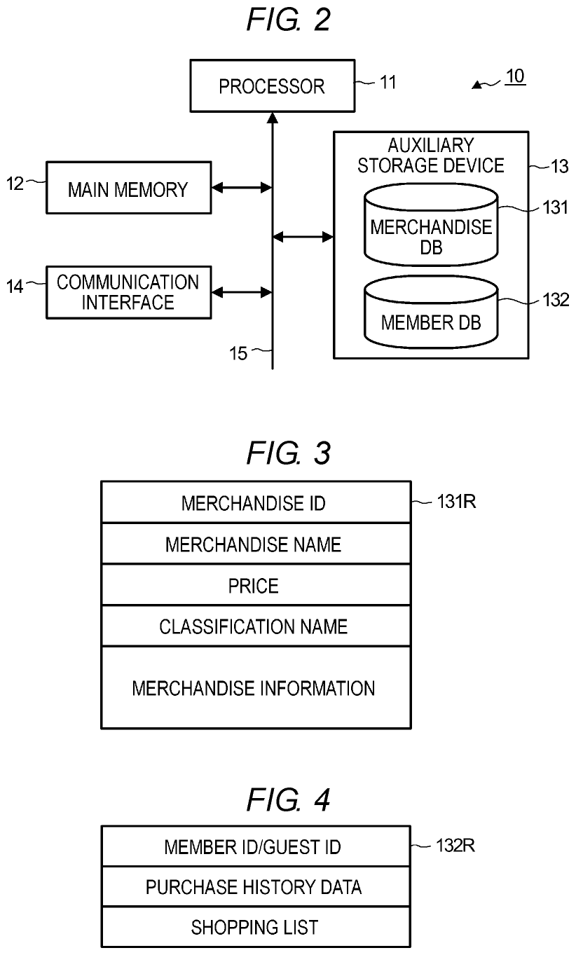

FIG. 2 is a block diagram illustrating a main circuit arrangement of the store server 10. The store server 10 includes a processor 11, a main memory 12, an auxiliary storage device 13, a communication interface 14, and a system transmission path 15. The system transmission path 15 includes an address bus, a data bus, a control signal line, and the like. The store server 10 connects the processor 11, the main memory 12, the auxiliary storage device 13, and the communication interface 14 to the system transmission path 15. In the store server 10, a computer is configured with the processor 11, the main memory 12, the auxiliary storage device 13, and the system transmission path 15 connecting therebetween.

The processor 11 corresponds to the central part of the above computer. The processor 11 controls each unit to realize various functions as the store server 10 according to an operating system and application programs. The processor 11 is, for example, a central processing unit (CPU).

The main memory 12 corresponds to the main memory portion of the computer. The main memory 12 includes a nonvolatile memory area and a volatile memory area. The main memory 12 stores the operating system and the application programs in a nonvolatile memory area. The main memory 12 sometimes stores data necessary for the processor 11 to control each part in a nonvolatile or volatile memory area. The main memory 12 uses a volatile memory area as a work area where data is appropriately rewritten by the processor 11. For example, the nonvolatile memory area is a read-only memory (ROM). The volatile memory area is a random access memory (RAM).

The auxiliary storage device 13 corresponds to an auxiliary storage part of the above computer. For example, electric erasable programmable read-only memory (EEPROM), hard disc drive (HDD), solid state drive (SSD), and the like are used as the auxiliary storage device 13. The auxiliary storage device 13 stores data used by the processor 11 in performing various kinds of processing and data created by processing in the processor 11. The auxiliary storage device 13 sometimes stores the above application programs.

The communication interface 14 transmits and receives data to and from each unit connected via the network 50 according to a communication protocol.

The store server 10 includes a merchandise database 131 and a member database 132 in the auxiliary storage device 13. In FIG. 2, the database is abbreviated as DB.

The merchandise database 131 stores data on each merchandise item to be sold in the store. FIG. 3 is a schematic diagram illustrating the main data structure of a merchandise data record 131R per merchandise item stored in the merchandise database 131. As illustrated in FIG. 3, the merchandise data record 131R includes items such as a merchandise ID, a merchandise name, a price, a classification name, and merchandise information.

The merchandise ID is a unique code set for each merchandise item in order to identify each merchandise item individually. The merchandise name and price are the name of the merchandise identified by the merchandise ID and the selling price per unit.

The classification name is information for identifying the classification to which the merchandise identified by the merchandise ID belongs. For example, merchandise “apple” has many varieties such as “Fuji”, “Jonagold”, and “Jonathan”, and a different merchandise ID is set for each type. However, for all varieties, the classification name is unified to “apple”.

The merchandise information is detailed information on the merchandise identified by the merchandise ID. The merchandise information includes, for example, a merchandise image, a merchandise name, a price, and a merchandise description of the merchandise. The merchandise description may include information such as raw materials, components and quantities, a manufacturer, a factory, and a place of origin, which are information to be used when the shopper determines whether to purchase the merchandise.

The member database 132 stores data relating to customers who have been registered as members, such as point members, so-called members. FIG. 4 is a schematic diagram illustrating a main data structure of a member data record 132R per member stored in the member database 132. As illustrated, the member data record 132R includes items such as a member ID, purchase history data, a shopping list, and the like.

The member ID is a unique code set for each member to identify each member individually. The member owns a recording medium on which the member ID is recorded. The recording medium is, for example, a magnetic card, a contact integrated circuit (IC) card, a non-contact IC card, a smartphone, that is, an information terminal 3, or the like.

The purchase history data is data indicating a purchase history indicating when and what the member identified by the member ID purchased.

The shopping list is data on merchandise that the member identified by the member ID plans to buy. The shopper can create a shopping list in advance before visiting the store by using a merchandise information display control program downloaded from the Web server 2 to the information terminal 3. The shopping list includes an item name that is purchase-planned item information indicating an item of merchandise that the shopper plans to buy, that is, an item of merchandise that the shopper wants to purchase. The item name may be a merchandise name set in the merchandise data record 131R or a classification name. That is, a shopper who plans to purchase merchandise “apple” regardless of the type may register “apple” as an item name in the shopping list. On the other hand, for example, a shopper who plans to purchase merchandise “apple” with a merchandise name of “Fuji Apple” may register “Fuji Apple” as an item name on the shopping list.

The member database 132 can temporarily store data on one-time members who are customers who are not members. A guest record, which is the member data record 132R for a one-time member, includes a guest ID instead of the member ID. Even if the shopper is not a member of the store, the shopper can receive services according to those of a member by using the guest ID issued by the merchandise information display control program. In the one-time member data record 132R, the purchase history data is ignored. After the shopping, the one-time member data record 132R is deleted from the member database 132.

The communication server 20 supports data communication processing performed between the store server 10 and the Web server 2 or an electronic money center (not illustrated) via a network INT such as the Internet or a dedicated network for electronic money. The electronic money center manages, for each registered user for electronic money, an electronic money database that stores an electronic money record in which data relating to the electronic money is described, and supports settlement by electronic money.

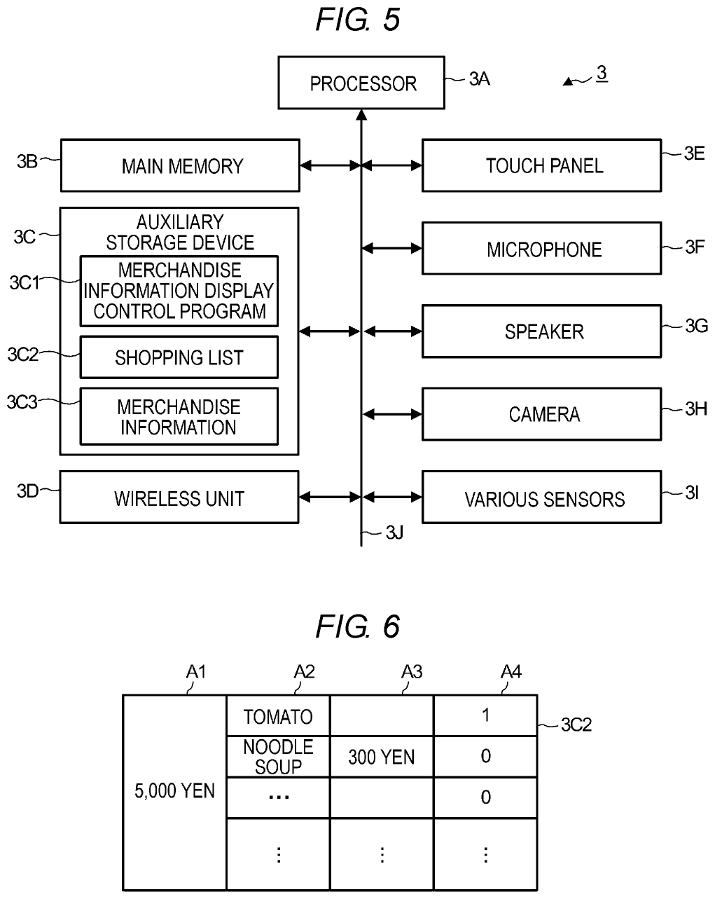

FIG. 5 is a block diagram showing a main circuit configuration of the information terminal 3. The information terminal 3 includes a processor 3A, a main memory 3B, an auxiliary storage device 3C, a wireless unit 3D, a touch panel 3E, a microphone 3F, a speaker 3G, a camera 3H, various sensors 3I, and a system transmission path 3J. The system transmission path 3J includes an address bus, a data bus, a control signal line, and the like. The information terminal 3 connects the processor 3A, the main memory 3B, the auxiliary storage device 3C, the wireless unit 3D, the touch panel 3E, the microphone 3F, the speaker 3G, the camera 3H, and the various sensors 3I to the system transmission path 3J. In the information terminal 3, a computer is configured with the processor 3A, the main memory 3B, the auxiliary storage device 3C, and the system transmission path 3J connecting therebetween.

The processor 3A corresponds to a central part of the computer. The processor 3A controls each unit to realize various functions according to an operating system and an application program. The processor 3A is, for example, a CPU.

The main memory 3B corresponds to a main storage part of the computer. The main memory 3B includes a nonvolatile memory area and a volatile memory area. The main memory 3B stores an operating system and application programs in the nonvolatile memory area. The main memory 3B may store data necessary for the processor 3A to execute processing for controlling each unit in the nonvolatile or volatile memory area. The main memory 3B uses the volatile memory area as a work area in which data is appropriately rewritten by the processor 3A. For example, the nonvolatile memory area is ROM. The volatile memory area is RAM.

The auxiliary storage device 3C corresponds to an auxiliary storage part of the computer. For example, an EEPROM or an SSD is used as the auxiliary storage device 3C. The auxiliary storage device 3C stores data used by the processor 3A to perform various types of processing and data created by the processing in the processor 3A. The auxiliary storage device 3C may store the above application program.

The wireless unit 3D wirelessly transmits and receives data to and from each unit according to a communication protocol. For example, the wireless unit 3D can communicate with a mobile phone base station (not illustrated), connect to a telephone network, and provide a call function. The wireless unit 3D performs wireless communication with an access point (not illustrated) disposed at a shopper's home, office, street, or the like to exchange information with the Web server 2 via the network INT such as the Internet. When entering the store, the wireless unit 3D can perform wireless communication with the access point 40 of the store system 1 to exchange information with the store server 10.

The touch panel 3E is a device that includes both an input device and a display device of the information terminal 3. The microphone 3F is an input device for inputting voice, and the speaker 3G is an output device for outputting voice and music. The camera 3H is an input device for capturing an image. The various sensors 3I may include an illuminance sensor for measuring brightness, a GPS sensor for measuring a position, a gyro sensor for measuring a posture, and the like.

The information terminal 3 can include a merchandise information display control program 3C1, a shopping list storage unit 3C2, and a merchandise information storage unit 3C3 in the auxiliary storage device 13. The merchandise information display control program 3C1 is an application program for causing a computer having the processor 3A as a central part to execute processing of creating a shopping list, processing of displaying merchandise information, and the like.

The shopping list storage unit 3C2 stores a shopping list created by the shopper's operation by executing the merchandise information display control program 3C1. FIG. 6 is a schematic diagram illustrating the main data structure of the shopping list storage unit 3C2. The shopping list storage unit 3C2 has areas A1 to A4 for describing information of a total budget, an item name, an individual budget, and a purchase flag. The area A1 is an area for describing the total amount of the budget to be used for this time of shopping. The area A2 is an area for describing a merchandise name or a classification name, which is an item name of merchandise to be purchased. The area A3 is an area for describing a budget amount that can be used for each merchandise item. The area A4 is an area for describing a purchase flag indicating whether each merchandise item has been purchased. The purchase flag is reset to “0” at the stage when the shopping list is created, and “1” is set by purchasing the corresponding merchandise.

The merchandise information storage unit 3C3 is an area for storing merchandise information transmitted from the store server 10 of the store system 1 based on the shopping list.

Hereinafter, the main operations of the merchandise information display system according to the first embodiment will be described. The content of the processing described below is an example. The processing procedure and processing content are not particularly limited as long as a similar result can be obtained.

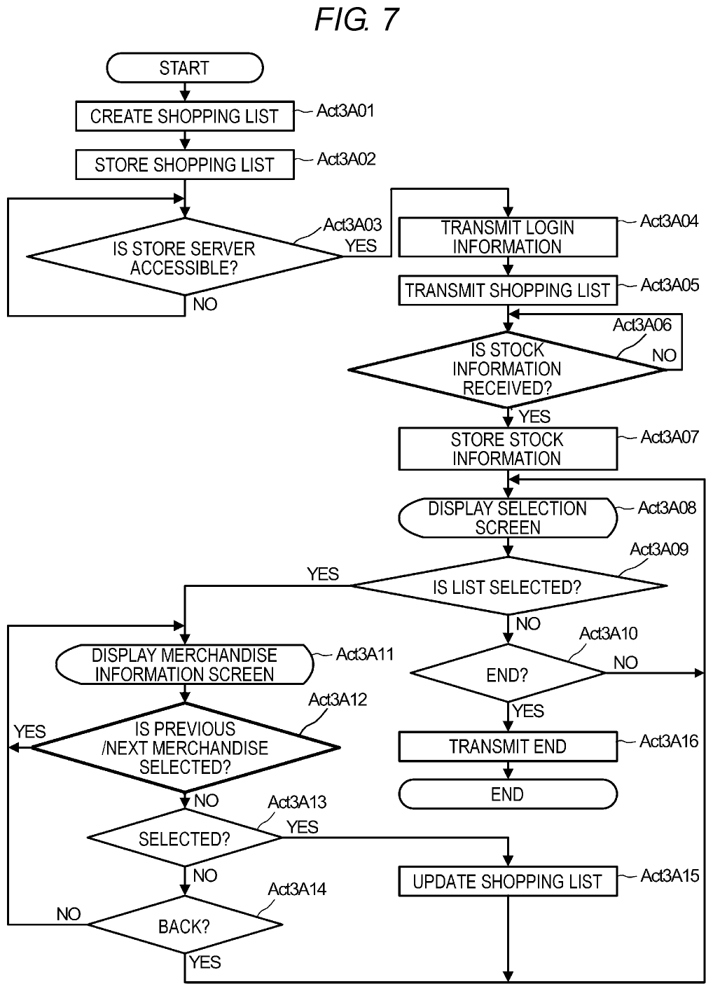

FIG. 7 is a flowchart illustrating a procedure of main information processing executed by the processor 3A of the information terminal 3 according to the product information display control program. First, the processor 3A creates a shopping list (Act 3A01).

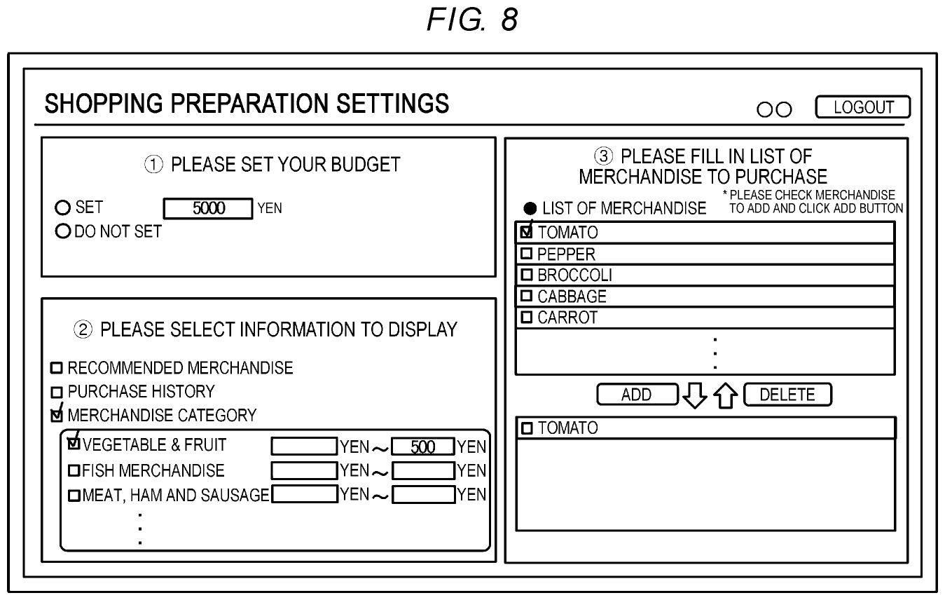

FIG. 8 is a schematic diagram illustrating an example of a shopping list creation screen displayed on the touch panel 3E of the information terminal 3 at this time. As illustrated in FIG. 8, in the shopping list, the budget to be used in this time of shopping, the merchandise name or the classification name of merchandise to be purchased, and the like can be specified. If the shopper is a member of the store and is logged in with a member ID, the Web server 2 may be used for the shopper to narrow down merchandise from the store server 10 of the store, such as merchandise based on the purchase history of the shopper and recommended merchandise.

When a shopping list is created, the processor 3A stores the content in the shopping list storage unit 3C2 of the auxiliary storage device 3C (Act 3A02).

Then, the processor 3A waits for the shopper to visit the store, establish wireless communication with the access point 40 of the store system 1 by the wireless unit 3D, and enable access to the store server 10 (Act 3A03). Communication setting information for the wireless unit 3D to establish communication with the access point 40 is stored in the auxiliary storage device 3C as a part of the merchandise information display control program.

If the processor 3A determines that access to the store server 10 is enabled (Act 3A03: YES), the processor 3A transmits the login information to the store server 10 and receives authentication (Act 3A04). This login information includes a member ID if the member is a member of the store. Otherwise, the login information includes a guest ID.

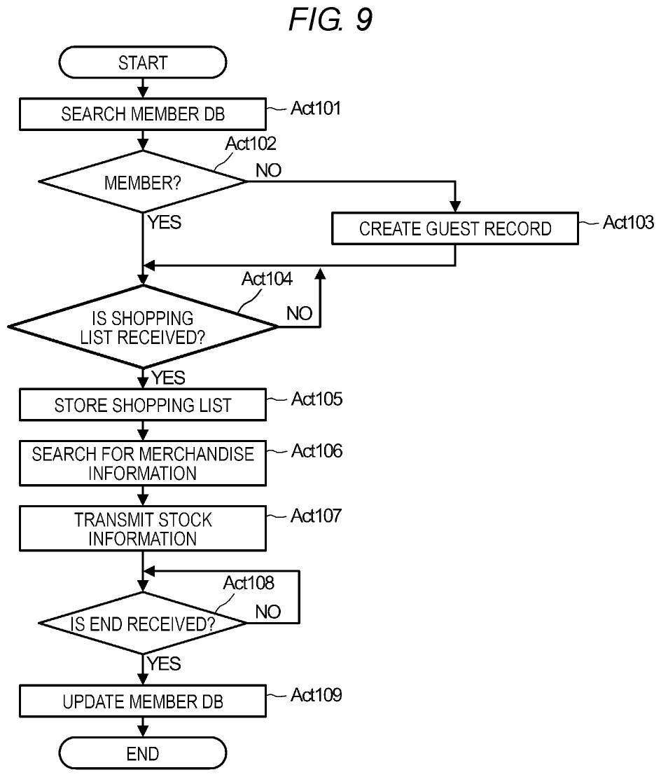

FIG. 9 is a flowchart illustrating a procedure of information processing related to merchandise information display executed by the processor 11 of the store server 10. The processor 11 starts the procedure illustrated in the flowchart in response to the reception of the login information from the information terminal 3 through the communication interface 14. First, the processor 11 searches the member database 132 based on the ID included in the received login information (Act 101) and determines whether the shopper is a member (Act 102). If it is determined that the shopper is not a member (Act 102: NO), the processor 11 creates a guest record which is a member data record 132R for the one-time member in the member database 132 (Act 103).

Thereafter, or when it is determined in Act 102 that the shopper is a member (Act 102: YES), the processor 11 transmits authentication OK to the information terminal 3 by the wireless unit 3D and waits for the information of the shopping list to be transmitted from the information terminal 3 (Act 104).

As illustrated in FIG. 7, the processor 3A of the information terminal 3 transmits the information of the shopping list stored in the shopping list storage unit 3C2 to the store server 10 by the wireless unit 3D (Act 3A05). Then, the processor 3A waits for the stock information to be transmitted from the store server 10 (Act 3A06).

As illustrated in FIG. 9, when it is determined that the information of the shopping list has been received from the information terminal 3 through the communication interface 14 (Act 104: YES), the processor 11 of the store server 10 stores the received information of the shopping list in the corresponding member data record 132R of the member database 132 (Act 105). Then, based on the information of the shopping list stored in the member data record 132R, the processor 11 searches the merchandise database 131 and acquires merchandise information (Act 106). That is, if the merchandise name of merchandise exists as an item name in the shopping list, the processor 11 acquires the merchandise information on the corresponding merchandise. If a classification name exists as an item name in the shopping list, the processor 11 acquires the merchandise information for all the merchandise corresponding to the classification. Then, the processor 11 transmits the stock information including the acquired merchandise information to the information terminal 3 through the communication interface 14 (Act 107). As a result of searching the merchandise database 131, for the merchandise that is out of stock or the merchandise that is not handled in the store, the processor 11 includes out-of-stock information instead of merchandise information in the stock information. Thereafter, the processor 11 waits for a termination instruction to be transmitted from the information terminal 3 (Act 108).

As illustrated in FIG. 7, when it is determined that the stock information from the store server 10 has been received by the wireless unit 3D (Act 3A06: YES), the processor 3A of the information terminal 3 stores the received stock information in the merchandise information storage unit 3C3 of the auxiliary storage device 3C (Act 3A07). Then, the processor 3A creates a selection screen based on the stock information and displays the selection screen on the touch panel 3E (Act 3A08).

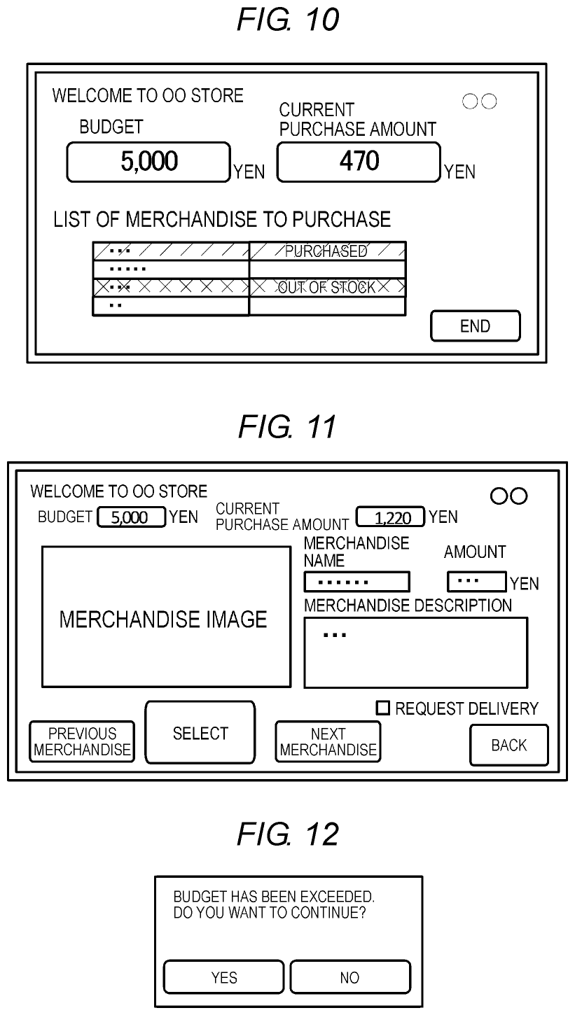

FIG. 10 is a schematic diagram illustrating an example of a selection screen displayed on the touch panel 3E of the information terminal 3. As illustrated in FIG. 10, on the selection screen, the budget to be used in this time of shopping, the list of merchandise to be purchased, which is a list of item names of the merchandise to be purchased, and a current purchase amount can be displayed. The current purchase amount is the total price of the merchandise selected to be purchased on the merchandise information screen as described later.

Purchased merchandise is identified and displayed in the list of merchandise to be purchased on the selection screen. This allows the shopper to easily determine which merchandise is not purchased.

In the list of merchandise to be purchased on the selection screen, according to out-of-stock information included in the stored stock information, the merchandise that is not in stock or the merchandise that is not handled in the store is identified and displayed as “out of stock”. This eliminates the need for the shopper to search for the merchandise that is not in the store.

When the selection screen is displayed in this manner, the processor 3A determines whether the position corresponding to one of the merchandise items to be purchased on the selection screen of the touch panel 3E has been touched, that is, determines whether a list has been selected by the shopper (Act 3A09). When it is determined that a list has not been selected (Act 3A09: NO), the processor 3A determines whether the position corresponding to the [End] button image on the selection screen of the touch panel 3E has been touched (Act 3A10). When it is determined that the position corresponding to the [End] button image on the selection screen of the touch panel 3E has not been touched (NO in Act 3A09), the processor 3A returns the control processing to Act 3A08.

When it is determined that the list has been selected by the shopper (Act 3A09: YES), the processor 3A creates a merchandise information screen from the merchandise information of the corresponding merchandise in the stock information stored in the merchandise information storage unit 3C3 and displays the merchandise information screen on the touch panel 3E (Act 3A11).

FIG. 11 is a schematic diagram illustrating an example of a merchandise information screen displayed on the touch panel 3E of the information terminal 3. As illustrated in FIG. 11, on the merchandise information screen, a merchandise image, a merchandise name, an amount, a merchandise description, and the like, which are merchandise information on candidate merchandise, can be displayed. If the list selected by the shopper includes item names, a plurality of merchandise items may correspond. In such a case, the merchandise information screen can include a [Previous Merchandise] button image and a [Next Merchandise] button image so that merchandise information on other candidate merchandise can be browsed. When there are a plurality of such products, the order in which the merchandise information of the candidate merchandise is displayed may be determined by system design or may be specified in advance by the shopper when creating the shopping list. For example, the recommendation order may be such that merchandise recommended by the store is preferentially selected as candidate merchandise. The order includes, for example, displaying the number of merchandise items to be sold at the store in descending order, displaying the merchandise on sale first, and the like. Displaying the merchandise with price in ascending order, displaying the merchandise with the price per unit in ascending order, displaying the merchandise with points added on purchase in descending order, and the like can be considered. When the shopper is a member, since the purchase history data of the shopper is stored in the member database 132, the order of candidates is determined based on the data, thereby providing information reflecting the shopper's preferences.

The merchandise information screen also includes a [Select] button image that is touched when the shopper purchases the displayed candidate merchandise. The shopper can touch the position corresponding to the [Select] button image at any time before and after putting the merchandise in the shopping basket.

The merchandise information screen can include a checkbox to be checked when a delivery request is desired. For example, when purchasing heavy goods such as rice and beverages, by touching the position corresponding to this checkbox and checking the box, and then touching the position corresponding to the [Select] button image, it is possible to request delivery of the corresponding merchandise. When the shopper is a member, delivery is possible by registering the delivery destination of the shopper in the member database 132. Therefore, for a shopper who logs in with a guest ID that is not a member, the checkbox is set to a state where selection is impossible. It goes without saying that the actual delivery must be performed for the merchandise specified for the delivery after confirming that the price has been paid at the POS terminal 30 at the time of checkout.

The shopper can select a list at any time. For example, the shopper can select one of the items to display the merchandise information screen, proceed to the corner of the merchandise shelf on which the merchandise of the corresponding item is displayed in that state, and determine the merchandise to purchase while viewing the merchandise information. Conversely, on the merchandise selection screen, the shopper can also check the list of merchandise to purchase and proceed to the corner of the merchandise shelf on which the merchandise of any item is displayed, select the list of the item there, display a merchandise information screen, and determine the merchandise to purchase while viewing the merchandise information.

After displaying the merchandise information screen on the touch panel 3E in Act 3A11, the processor 3A determines whether the position corresponding to the [Previous Merchandise] button image or the [Next Merchandise] button image has been touched (Act 3A12). When it is determined that the position corresponding to the [Previous Merchandise] button image or the [Next Merchandise] button image has been touched (Act 3A12: YES), the processor 3A returns the control processing to Act 3A11. Returning to Act 3A11, the processor 3A displays a merchandise information screen for the previous or next candidate merchandise on the touch panel 3E.

When it is determined that the position corresponding to the [Previous Merchandise] button image or the [Next Merchandise] button image has not been touched (Act 3A12: NO), the processor 3A determines whether the position corresponding to the [Select] button image has been touched (Act 3A13). When it is determined that the position corresponding to the [Select] button image has not been touched (Act 3A13: NO), the processor 3A determines whether the position corresponding to the [Back] button image has been touched (Act 3A14). When it is determined that the position corresponding to the [Back] button image has not been touched (Act 3A14: NO), the processor 3A returns the control processing to Act 3A11 and continues to display the merchandise information screen for the candidate merchandise. On the other hand, when it is determined that the position corresponding to the [Back] button image has been touched (YES in Act 3A14), the processor 3A returns the control processing to Act 3A08 and displays the selection screen on the touch panel 3E.

When it is determined that the position corresponding to the [Select] button image has been touched (Act 3A13: YES), the processor 3A updates the shopping list stored in the shopping list storage unit 3C2 of the auxiliary storage device 3C (Act 3A15). That is, the purchase flag of the area A4 corresponding to the merchandise name or classification name of the merchandise in the shopping list storage unit 3C2 is set to “1”. Thereafter, the processor 3A returns the control processing to Act 3A08. As a result, on the displayed selection screen, the merchandise to be purchased is identified and displayed as purchased merchandise.

When the position corresponding to the [Select] button image has been touched, the processor 3A calculates the total purchase amount of purchased merchandise, and when the total purchase amount exceeds the set budget, for example, as illustrated in FIG. 12, an alert screen indicating that fact is displayed as a pop-up. That is, when the shopper attempts to select merchandise to exceed the budget, he or she confirms whether the budget can be exceeded. The alert screen only needs to be displayed at the time of first selection exceeding the budget.

Thus, the shopper can purchase desired merchandise at the corner of the merchandise shelf on which the merchandise of the corresponding item is displayed while viewing the selection screen or the merchandise information screen.

When it is determined that the position corresponding to the [End] button image on the selection screen has been touched (Act 3A310: YES), the processor 3A transmits an end instruction to the store server 10 by the wireless unit 3D (Act 3A05). Then, the processor 3A ends the operation according to the merchandise information display control program. The end instruction includes information for identifying the purchased merchandise.

As illustrated in FIG. 9, when the processor 11 of the store server 10 determines that an end instruction has been received from the information terminal 3 through the communication interface 14 (Act 108: YES), the processor 11 updates the member database (Act 109). That is, when the shopper is a member, the information of the purchased merchandise included in the end instruction is added to the purchase history data of the corresponding member data record 132R of the member database. When the shopper is not a member, the guest record which is a member data record 132R for the one-time member created in the member database is deleted. Then, the information processing related to the display of the merchandise information ends.

As described above, according to the at least one embodiment, the information terminal 3 stores the shopping list including the purchase-planned item information indicating an item of merchandise that the shopper wants to purchase in the shopping list storage unit 3C2 as the first storage unit. Thereafter, when the shopper carrying this information terminal 3 visits the store and information can be exchanged between the information terminal 3 and the store server 10, the store server 10 acquires the shopping list including the purchase-planned item information from the information terminal 3, searches the merchandise database based on the purchase-planned item information, and checks the stock of the merchandise of the item that the shopper wants to purchase. Then, the store server 10 transmits stock information including the stock availability of the merchandise of the item that the shopper wants to purchase to the information terminal 3, and the information terminal 3 displays, as a selection screen, the stock availability of the corresponding merchandise on the touch panel 3E as a display unit. Therefore, it is possible to notify the shopper whether the merchandise that the shopper wants to purchase is available.

The stock information transmitted from the store server 10 to the information terminal 3 includes the merchandise information on each merchandise item of the corresponding item in stock, and the information terminal 3 stores the merchandise information on each of the merchandise of the corresponding item in stock in the merchandise information storage unit 3C3 as a second storage unit. Then, the processor 3A functioning as a display control unit of the information terminal 3 displays merchandise information on at least one type of candidate merchandise selected from the merchandise stored in the merchandise information storage unit 3C3 on the touch panel 3E. When the item specified by the shopper in the shopping list is a classification name, there are a plurality of merchandise items corresponding to the item. When the shopper determines an item to purchase but has not determined merchandise, he or she determines merchandise to purchase based on not only the price of the merchandise but also his or her own viewpoint that the shopper prioritizes, such as quantity, ingredient, and place of origin. In order to make this determination, the shopper needs to read the information written on the label attached to the merchandise while taking each merchandise item arranged on the merchandise shelf of the store one by one. Even if only the price is prioritized, the position of the price tag specified on the merchandise shelf may be shifted from actual merchandise. According to the present embodiment, the shopper can check the merchandise information on the merchandise arranged on the merchandise shelf on the display of the touch panel 3E of the information terminal 3, and therefore he or she does not need to check the actual merchandise by hand, and even if the position of the actual merchandise and the price tag do not match, it is possible to know the correct price of the merchandise.

### Second Embodiment

The shopping list created by the information terminal 3 may be stored in the Web server 2 instead of being stored in the auxiliary storage device 3C. In that case, the shopping list storage unit 3C2 is not provided in the auxiliary storage device 3C. Instead of transmitting the merchandise information from the store server 10 to the information terminal 3, a screen including the merchandise information may be transmitted as image information. In that case, the merchandise information storage unit 3C3 is not provided in the auxiliary storage device 3C. A case having such a configuration will be described as a second embodiment.

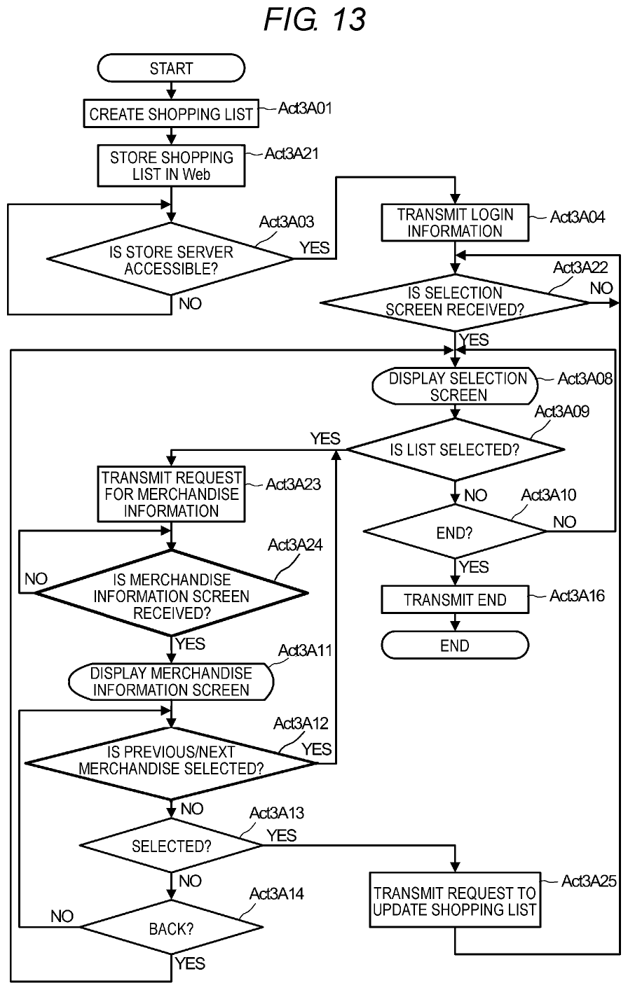

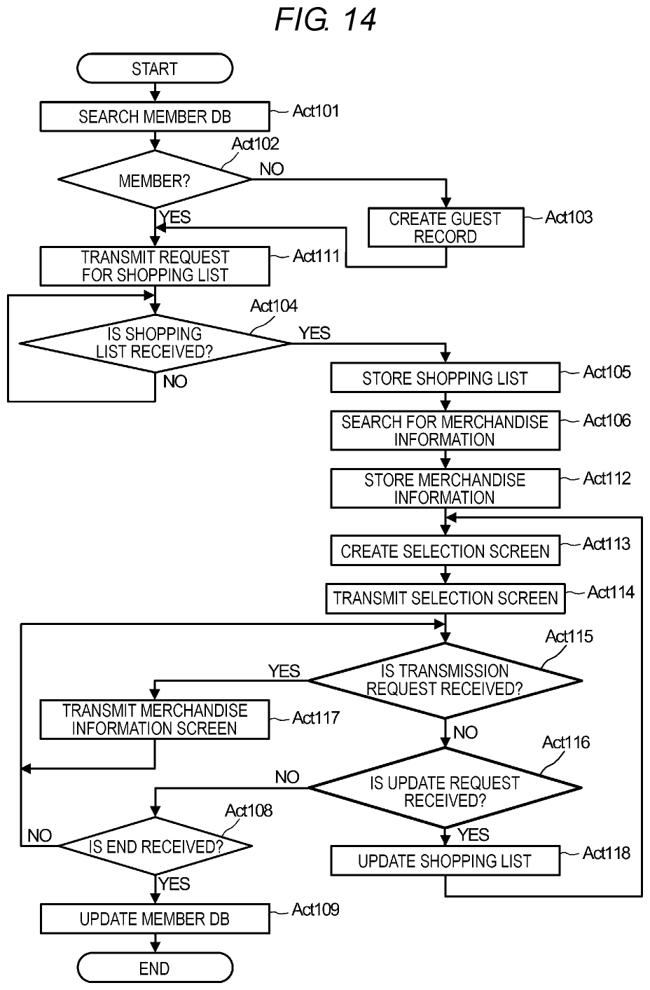

FIG. 13 is a flowchart illustrating a procedure of main information processing executed by the processor 3A of the information terminal 3 in the second embodiment, and FIG. 14 is a flowchart illustrating a procedure of main information processing executed by the processor 11 of the store server 10 in the second embodiment. Hereinafter, a procedure of information processing in the second embodiment will be described with reference to these drawings, but the same procedures as those in the first embodiment will be given the same reference numerals as in FIGS. 7 and 9, and the description thereof will be omitted.

As illustrated in FIG. 13, the processor 3A of the information terminal 3 stores the content of the shopping list created in Act 3A01 in a storage unit managed by the Web server 2 via the network INT such as the Internet by the wireless unit 3D (Act 3A21). Thereafter, as in the first embodiment, when the shopper carrying the information terminal 3 visits the store and access to the store server 10 is enabled, the login information is transmitted to the store server 10. Here, in the second embodiment, since the information of the shopping list is not stored in the information terminal 3, the information of the shopping list is not transmitted as in Act 3A05 of the first embodiment, and the information terminal 3 waits for the image information of the selection screen including the stock information to be transmitted from the store server 10 (Act 3A22).

As illustrated in FIG. 14, when it is determined that the shopper is a member in Act 102, or after creating a guest record that is a member data record 132R for a one-time member in the member database 132 in Act 103, the processor 11 of the store server 10 that has received the login information transmits a shopping list request to the Web server 2 via the network INT such as the Internet through the communication interface 14 (Act 111). The shopping list request includes the member ID or the guest ID included in the login information received from the information terminal 3. Then, the processor 11 advances the control processing to Act 104 and waits for the shopping list information to be transmitted from the Web server 2.

The Web server 2 identifies the shopping list stored in the storage unit based on the member ID or the guest ID and sends a reply including the information of the shopping list to the store server 10. Upon receiving the information of the shopping list from the Web server 2 through the communication interface 14, the processor 11 stores the received information of the shopping list in the corresponding member data record 132R of the member database 132, as in the first embodiment and acquires the merchandise information from the merchandise database 131 based on the information of the shopping list. Then, the processor 11 stores the acquired merchandise information in the corresponding member data record 132R of the member database 132 (Act 112). Next, the processor 11 creates image information of a selection screen to be displayed on the information terminal 3 based on the stored shopping list information and the merchandise information (Act 113). The image information on the selection screen includes the stock information as illustrated in FIG. 10. Then, the processor 11 transmits the created image information of the selection screen to the information terminal 3 through the communication interface 14 (Act 114).

Thereafter, the processor 11 determines whether a merchandise information request has been received from the information terminal 3 through the communication interface 14 (Act 115). When it is determined that a merchandise information request has not been received (Act 115: NO), the processor 11 determines whether the communication interface 14 has received a shopping list update request from the information terminal 3 (Act 116). When it is determined that a shopping list update request has not been received (Act 116: NO), the processor 11 determines whether an end instruction has been received from the information terminal 3 through the communication interface 14 (Act 108). When it is determined that an end instruction has not been received (Act 108: NO), the processor 11 returns the control processing to Act 115. In this way, the processor 11 waits to receive a merchandise information request, a shopping list update request, or an end instruction from the information terminal 3.

As illustrated in FIG. 13, upon receiving the image information of the selection screen from the store server 10 by the wireless unit 3D (Act 3A22: YES), the processor 3A of the information terminal 3 displays the selection screen based on the received image information on the touch panel 3E (Act 3A08). Thereafter, the processor 3A waits for the shopper to select a list or to touch the position corresponding to the [End] button image on the selection screen.

When a list is selected by the shopper, the processor 3A transmits a merchandise information request for a merchandise information screen for merchandise corresponding to the touched position to the store server 10 by the wireless unit 3D (Act 3A23). Thereafter, the processor 3A waits for the image information of the merchandise information screen to be transmitted from the store server 10 (Act 3A24).

As illustrated in FIG. 14, when it is determined that a merchandise information request from the information terminal 3 has been received through the communication interface 14 (Act 115: YES), the processor 11 of the store server 10 creates image information of the merchandise information screen from the merchandise information of the corresponding merchandise stored in the corresponding member data record 132R of the member database 132 and transmits the created image information of the merchandise information screen to the information terminal 3 through the communication interface 14 (Act 117). Thereafter, the processor 11 returns the control processing to Act 115.

As illustrated in FIG. 13, when the image information of the merchandise information screen is received from the store server 10 by the wireless unit 3D (Act 3A24: YES), the processor 3A of the information terminal 3 displays a merchandise information screen based on the received image information on the touch panel 3E (Act 3A11). Thereafter, as in the first embodiment, the processor 3A waits for positions corresponding to the [Previous Merchandise] button image, the [Next Merchandise] button image, the [Select] button image, and the [Back] button image on the merchandise information screen to be touched.

When the position corresponding to the [Previous Merchandise] button image or the [Next Merchandise] button image is touched, the processor 3A returns the control processing to Act 3A23 and transmits to the store server 10 a merchandise information request for requesting a merchandise information screen for the previous or next merchandise.

When the position corresponding to the [Back] button image is touched, the processor 3A returns the control processing to Act 3A08 and displays the selection screen on the touch panel 3E.

When it is determined that the position corresponding to the [Select] button image has been touched (Act 3A13: YES), the processor 3A transmits a shopping list update request for requesting an update of the shopping list to the store server 10 by the wireless unit 3D (Act 3A25). Thereafter, the processor 3A returns the control processing to Act 3A22 and waits for the updated image information of the new selection screen to be transmitted.

As illustrated in FIG. 14, when it is determined that a shopping list update request has been received from the information terminal 3 through the communication interface 14 (Act 116: YES), the processor 11 of the store server 10 updates the information of the shopping list stored in the corresponding member data record 132R of the member database 132 (Act 118). That is, the purchase flag in the shopping list information is set to “1”. Thereafter, the processor 11 returns the control processing to Act 113 and creates updated new image information of the selection screen.

As described above, according to at least one embodiment, the information terminal 3 causes the Web server 2 as the first storage unit to store the shopping list including the purchase-planned item information indicating the item of the merchandise that the shopper wants to purchase. After that, when the shopper carrying the information terminal 3 visits the store and information can be exchanged between the information terminal 3 and the store server 10, the store server 10 acquires a shopping list including the purchase-planned item information set by the shopper from. the Web server 2, searches the merchandise database based on the purchase-planned item information, and checks the stock of the merchandise of the item that the shopper wants to purchase. Then, the store server 10 creates image information of the selection screen including the stock information indicating the stock availability of the merchandise of the item that the shopper wants to purchase, and transmits the image information to the information terminal so that the information terminal 3 displays the stock availability of the corresponding merchandise as a selection screen on the touch panel 3E as a display unit. Therefore, it is possible to notify the shopper of the availability of the merchandise that the shopper wants to purchase.

The store server 10 further transmits, to the information terminal 3, merchandise information on at least one type of candidate merchandise selected from the merchandise of the corresponding item in stock as image information on the merchandise and displays the merchandise information on the touch panel 3E of the information terminal 3. Therefore, the shopper can check the merchandise information on the merchandise arranged on the merchandise shelf on the display of the touch panel 3E of the information terminal 3, and therefore he or she does not need to check the actual merchandise by hand, and even if the position of the actual merchandise and the price tag do not match, it is possible to know the correct price of the merchandise.

### Third Embodiment

In the first embodiment, the shopper displays a merchandise information screen at any time, but a selection screen may be switched to a merchandise screen without depending on the shopper's instruction. This will be described as a third embodiment.

For example, by installing an RFID tag or the like that transmits the item information of merchandise on a merchandise shelf where the merchandise is displayed and giving the wireless unit 3D of the information terminal 3 a function of reading this RFID tag, the processor 3A of the information terminal 3 can detect which item of merchandise the information terminal 3 is located near.

A plurality of fixed base stations are installed in the store, Bluetooth (Bluetooth is a registered trademark) low energy (BLE) waves and ultra-wideband (UWB) waves are transmitted from each fixed base station, and the BLE waves are received by the wireless unit 3D of the information terminal 3, and the position coordinates of the information terminal 3 can be measured based on the respective incident angles and arrival times of the BLE waves. If the information terminal 3 has a coordinate map in the store, by comparing the measured position coordinates with the map, the processor 3A can detect which item of merchandise the information terminal 3 is located near.

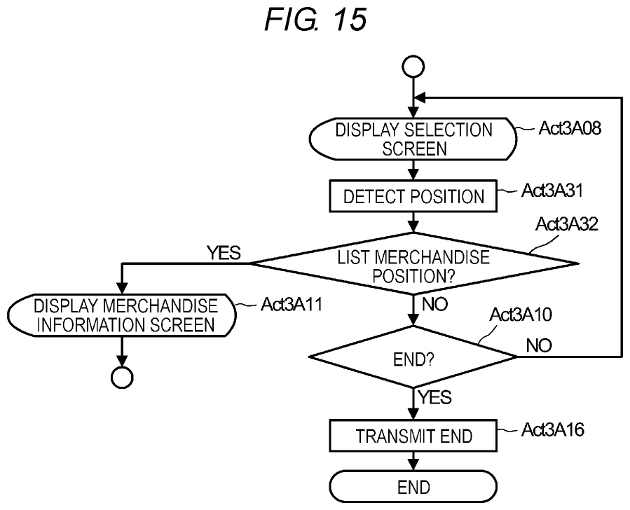

FIG. 15 is a flowchart illustrating a part of a procedure of the main information processing executed by the processor 3A of the information terminal 3 in the third embodiment. Hereinafter, the procedure of the information processing in the third embodiment will be described with reference to FIG. 15, but the same procedures as those in the first embodiment will be given the same reference numerals as in FIG. 7, and the description thereof will be omitted.

As illustrated in FIG. 15, after displaying the selection screen in Act 3A08, the processor 3A of the information terminal 3 detects the position of the information terminal 3 (Act 3A31). Then, the processor 3A determines whether the detected position of the information terminal 3 is the position of the listed merchandise (Act 3A32). That is, the processor 3A determines whether the information terminal 3 has reached the position of the merchandise shelf on which the merchandise corresponding to the item described in the shopping list is displayed. When it is determined that the detected position of the information terminal 3 is not the position of the listed merchandise (Act 3A32: NO), the processor 3A advances the control processing to Act 3A10. Then, when it is determined that the detected position of the information terminal 3 is the position of the listed merchandise (Act 3A32: YES), the processor 3A advances the control processing to Act 3A11 and displays the merchandise information screen.

As described above, according to the present embodiment, the information terminal 3 detects the position of the information terminal 3 in the store, selects an appropriate merchandise image according to the detection result, and displays the selected merchandise image on the touch panel 3E. Therefore, it is possible to save the trouble of the shopper.

### Fourth Embodiment

The switching from the selection screen to the merchandise screen based on the position detection as in the third embodiment can be performed even when the shopping list is stored in the Web server 2 as in the second embodiment. This will be described as a fourth embodiment.

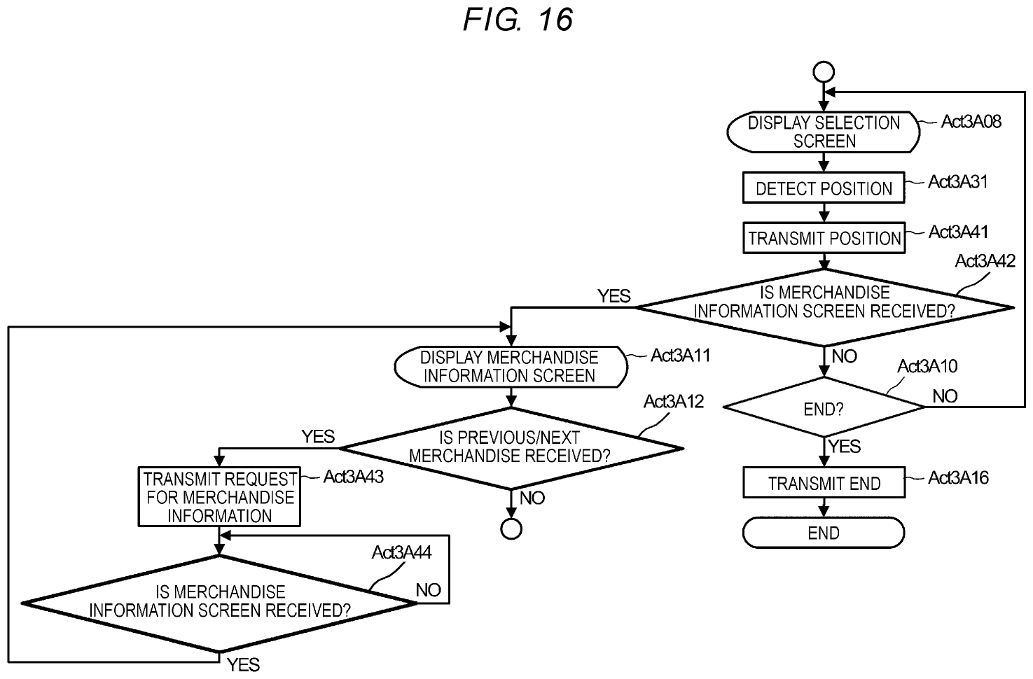

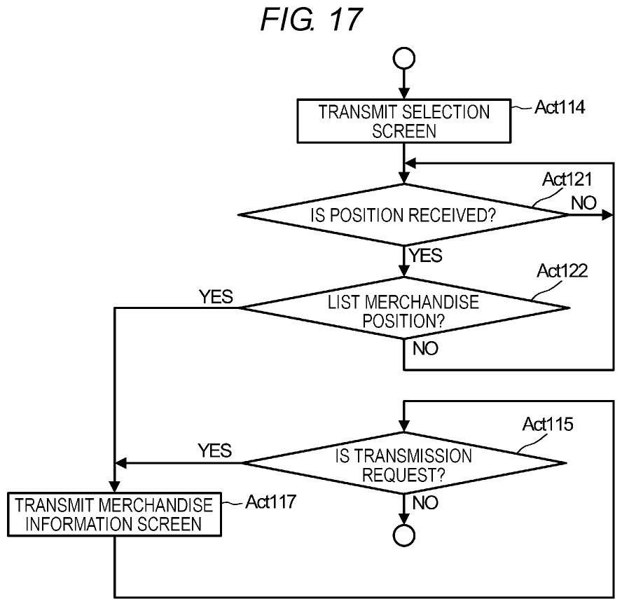

FIG. 16 is a flowchart illustrating a part of a procedure of main information processing executed by the processor 3A of the information terminal 3 in the fourth embodiment, and FIG. 17 is a flowchart illustrating a part of a procedure of main information processing executed by the processor 11 of the store server 10 in the fourth embodiment. Hereinafter, the procedure of the information processing in the fourth embodiment will be described with reference to FIGS. 16 and 17, but the same procedures as those in the second embodiment will be given the same reference numerals as in FIGS. 13 and 14, and the description thereof will be omitted.

As illustrated in FIG. 16, after displaying the selection screen in Act 3A08, the processor 3A of the information terminal 3 detects the position of the information terminal 3 (Act 3A31). Then, the processor 3A transmits position information indicating the detected position of the information terminal 3 to the store server 10 by the wireless unit 3D (Act 3A41). Thereafter, the processor 3A determines whether the image information of the merchandise information screen has been received from the store server 10 (Act 3A42). When it is determined that the image information of the merchandise information screen has not been received from the store server (Act 3A42: NO), the processor 3A advances the control processing to Act 3A10.

As illustrated in FIG. 17, the processor 11 of the store server 10 transmits the image information of the selection screen to the information terminal 3 in Act 114, and then waits to receive the position information from the information terminal 3 through the communication interface 14 (Act 121). When it is determined that the position information has been received from the information terminal 3 (Act 121: YES), the processor 11 determines whether the information terminal 3 has reached the position of the merchandise shelf on which the merchandise corresponding to the item described in the shopping list stored in the corresponding member data record 132R of the member database 132. When it is determined that the detected position of the information terminal 3 is not the position of the listed merchandise (Act 122), the processor 11 returns the control processing to Act 121. Then, when it is determined that the detected position of the information terminal 3 is the position of the listed merchandise (Act 122: YES), the processor 11 advances the control processing to Act 117, creates image information of the merchandise information screen from the merchandise information of the corresponding merchandise stored in the member data record 132R, and transmits the created image information of the merchandise information screen to the information terminal 3 through the communication interface 14.

As illustrated in FIG. 16, when it is determined that the image information of the merchandise information screen has been received from the store server 10 (Act 3A42: YES), the processor 3A advances the control processing to Act 3A11 and displays the merchandise information screen based on the received image information on the touch panel 3E. Then, when the position corresponding to the [Previous Merchandise] button image or the [Next Merchandise] button image on the merchandise information screen is touched, the processor 3A transmits a merchandise information request for a merchandise information screen for merchandise corresponding to the touched position to the store server 10 by the wireless unit 3D (Act 3A43). Thereafter, the processor 3Awaits for the image information of the merchandise information screen to be transmitted from the store server 10 (Act 3A44). When the image information of the merchandise information screen is received from the store server 10 by the wireless unit 3D (Act 3A44: YES), the processor 3A returns the control processing to Act 3A11 and displays the merchandise information screen based on the received image information on the touch panel 3E.

Thus, according to the present embodiment, the information terminal 3 detects the position of the information terminal 3 in the store and transmits the detection result to the store server 10 so that an appropriate merchandise image is selected from the store server 10 according to the position of the information terminal 3, and the image information on the merchandise information screen is returned. Therefore, it is possible to save the trouble of the shopper.

### Fifth Embodiment

Next, as a fifth embodiment, a case where the store system 1 is a cart POS system will be described. In the cart POS system, a shopping cart is provided with an information terminal equipped with a touch panel, a scanner, and the like. When a shopper using a shopping cart places merchandise to purchase in the shopping cart, the shopper scans the identification code of the purchased merchandise with the scanner and registers the merchandise. As described above, in the cart POS system, since the shopper himself or herself performs the merchandise registration while shopping, it is possible to alleviate the congestion of the checkout place, that is, a so-called cash register.

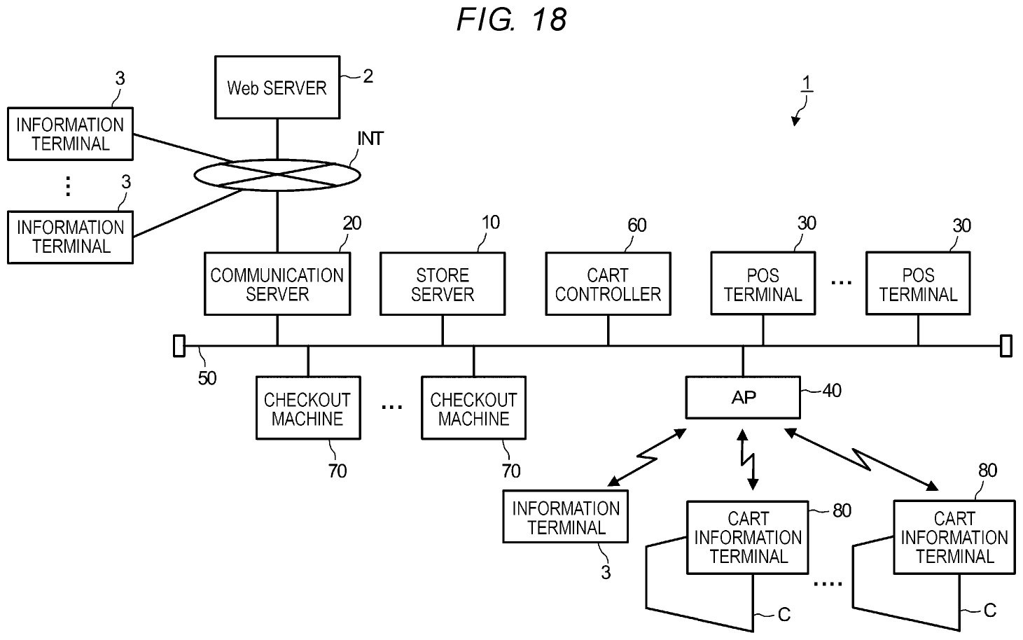

FIG. 18 is a block diagram illustrating an overall arrangement of a merchandise information display system according to the fifth embodiment. Here, the same components as those in the first embodiment are denoted by the same reference numerals as those in FIG. 1, and the description thereof will be omitted.

The store system 1 includes a cart controller 60, a plurality of checkout machines 70, and a plurality of cart information terminals 80, in addition to the store server 10, the communication server 20, the plurality of POS terminals 30, the access points 40, and the network 50 described above. The cart controller 60 and the plurality of checkout machines 70 are connected to the store server 10 via the network 50. The plurality of cart information terminals 80 can be connected to the store server 10 connected to the network 50 via the access point 40.

The cart controller 60 cooperates with the cart information terminal 80 to support the cart information terminal 80 as if the cart information terminal 80 functions as the POS terminal 30.

The checkout machine 70 is a device that allows the clerk or the shopper to perform checkout for purchased merchandise. The checkout machine 70 is a well-known self-service POS terminal. The number of checkout machines 70 is not particularly limited.

The cart information terminal 80 is a device that is lent to a shopper who visits the store to carry in the store, and which enables the shopper to input data relating to merchandise registration by himself or herself. The cart information terminal 80 is provided in the shopping cart C. Hereinafter, the shopping cart C is simply referred to as a cart C. Each of the plurality of carts C is provided with the cart information terminal 80. The cart C is an example of a transporter that transports merchandise that a shopper using the cart C wants to purchase.

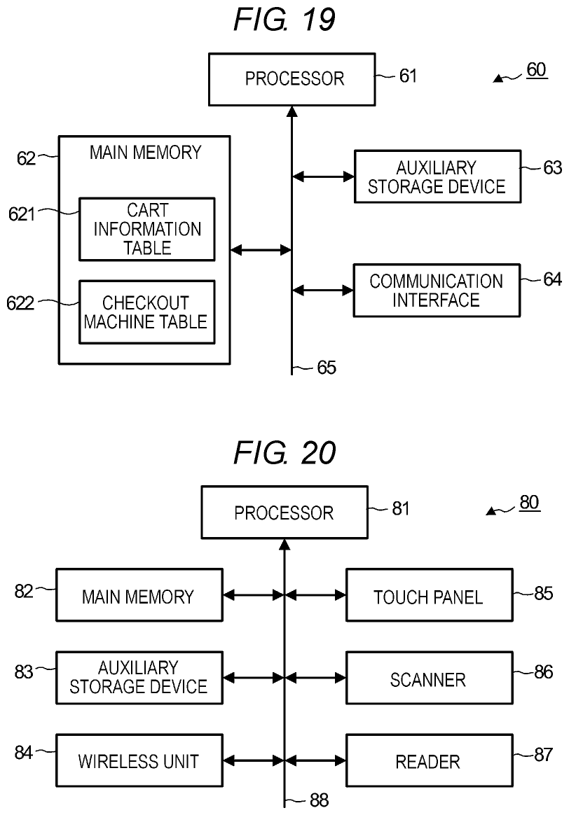

FIG. 19 is a block diagram illustrating a main circuit configuration of the cart controller 60. The cart controller 60 includes a processor 61, a main memory 62, an auxiliary storage device 63, a communication interface 64, and a system transmission path 65 and connects the processor 61, the main memory 62, the auxiliary storage device 63, and the communication interface 64 to the system transmission path 65. In the cart controller 60, a computer is configured with the processor 61, the main memory 62, the auxiliary storage device 63, and the system transmission path 65 connecting therebetween. The schematic description of the processor 61, the main memory 62, the auxiliary storage device 63, and the communication interface 64 may be the same as the description for the store server 10.

The cart controller 60 uses a part of the volatile area in the main memory 62 as a cart information terminal table 621 and a checkout machine table 622. The cart information terminal table 621 has an area for saving various information for each cart information terminal 80 provided for each cart C.

The cart information terminal table 621 has an area for describing information such as a terminal ID, a member ID, a registration list, and a checkout code. The terminal ID is a unique code set for each cart information terminal 80 in order to identify each cart information terminal 80 individually. The registration list is a list of information on merchandise registered in the cart information terminal 80 and describes a merchandise ID, a merchandise name, quantity, amount, and the like in a series of numbers. The checkout code is a code issued for each commercial transaction in order to identify a commercial transaction for which merchandise registration has been performed in the cart information terminal 80.

The checkout machine table 622 has an area for describing information such as a checkout machine ID, a checkout machine status, and the like. The checkout machine ID is a unique code set for each checkout machine 70 in order to identify each checkout machine 70 individually. The checkout machine status is information indicating the state of the checkout machine 70 identified by the checkout machine ID, whereby the processor 61 can determine which checkout machine 70 is in use.

FIG. 20 is a block diagram illustrating a main circuit configuration of the cart information terminal 80. The cart information terminal 80 includes a processor 81, a main memory 82, an auxiliary storage device 83, a wireless unit 84, a touch panel 85, a scanner 86, a reader 87, and a system transmission path 88. The system transmission path 88 includes an address bus, a data bus, a control signal line, and the like. The cart information terminal 80 connects the processor 81, the main memory 82, the auxiliary storage device 83, the wireless unit 84, the touch panel 85, the scanner 86, and the reader 87 to the system transmission path 88 directly or via a signal input/output circuit. In the cart information terminal 80, a computer is configured with a processor 81, a main memory 82, an auxiliary storage device 83, and a system transmission line 88 connecting therebetween. The schematic description of the processor 81, the main memory 82, the auxiliary storage device 83, and the wireless unit 84 may be the same as the description for the store server 10.

The touch panel 85 is a device including both an input device and a display device of the cart information terminal 80. The cart information terminal 80 can display an image on the touch panel 85 based on the image information created by the store server 10.

The scanner 86 includes a camera as an imaging unit. The scanner 86 reads a code symbol such as a barcode or a two-dimensional data code from an image captured by the camera.

The reader 87 reads the member ID recorded on a recording medium. The reader 87 is a magnetic card reader when the recording medium is a magnetic card, and is an IC card reader when the recording medium is a contact IC card. In the case of a recording medium. using RFID such as a non-contact IC card or a smartphone, an RFID reader is used as the reader 87.

In such a cart POS system, as in the second or fourth embodiment, the shopper creates a shopping list before visiting the store and stores the shopping list in the Web server 2. Then, when visiting the store, the shopper logs in by using the cart information terminal 80 instead of the information terminal 3. Thereby, the processor 61 of the cart information terminal 80 can execute the control processing after the shopper visits the store in the processing procedure of the information terminal 3 described in the second or fourth embodiment. Thus, the selection screen and the merchandise information screen are displayed on the touch panel 85 of the cart information terminal 80, and the shopper can browse the merchandise information as in the case where the shopper uses the information terminal 3 carried by himself or herself.

Thus, according to the present embodiment, the shopper accesses the Web server and stores the shopping list including the purchase-planned item information before visiting the store so that the shopper can browse the selection screen and the merchandise information screen by using the cart information terminal 80 lent to the shopper who has visited the store to carry in the store. Therefore, also in the fifth embodiment, the same effects as in the above-described second or fourth embodiment can be obtained.

The information terminal 3 carried by the shopper can be the same as any of the first to fourth embodiments described above.

The information terminal 3 can be used as an alternative to the cart information terminal 80. That is, since the scanner 86 can be realized by a barcode reader application program and the camera 3H, and the shopper is logged in the merchandise information display control program with the member ID, the reader 87 does not need to read the member ID.

As described above, while several embodiments of the present exemplary embodiment have been described, these embodiments have been presented byway of example and are not intended to limit the scope of the invention. These novel embodiments can be implemented in various other forms, and various omissions, replacements, and changes can be made without departing from the spirit of the invention. These embodiments and modification examples thereof are included in the scope and gist of the exemplary embodiment and are included in the exemplary embodiment described in the claims and the equivalent scope thereof.

What is claimed is:

1. A merchandise information display system comprising:
a store server configured to manage a merchandise database that stores merchandise information on each merchandise item available in a store;
an information terminal that includes a communication unit configured to communicate with an external device and a display unit configured to display information, the information terminal capable of being carried by a shopper in the store; and
a first storage unit that stores purchase-planned item information indicating an item of merchandise that the shopper wants to purchase, wherein
the store server
is configured to acquire the purchase-planned item information from the first storage unit when it is possible to exchange information with the information terminal,
configured to search the merchandise database based on the purchase-planned item information and to check stock of an item of merchandise that the shopper wants to purchase, and
configured to transmit and display stock information including stock availability of the item of merchandise that the shopper wants to purchase on the display unit of the information terminal,
wherein the information terminal further comprising a position detector arranged to detect a position of the information terminal within the store, the information terminal configured to allow the shopper to select items of the purchase-planned item information which have been determined to have a same position as the detected position of the information terminal within the store.

2. The system according to claim 1, wherein the information terminal includes at least one of a smart phone or a tablet.

3. The system according to claim 1, wherein the information terminal includes a touch panel and the display unit of the information terminal.

4. The system according to claim 3, wherein the touch panel is configured to allow a user to create a shopping list of items of merchandise corresponding to the purchased-planned item information.

5. The system according to claim 1, further comprising a cart supporting the information terminal.

6. The system according to claim 1, the information terminal further comprising a display control unit configured to display an alert screen when selected items of the purchase-planned item information exceed a set budget.

7. The system according to claim 1, wherein
the store server is further configured to transmit to the information terminal merchandise information on at least one candidate merchandise item selected from among merchandise in stock, and to display the merchandise information on the display unit of the information terminal.

8. The system according to claim 1, wherein
the information terminal is provided to a shopper who visits the store to carry the information terminal in the store,
the first storage unit is managed by a Web server accessible by the store server, and
before visiting the store, the shopper accesses the Web server and stores the purchase-planned item information in the first storage unit.

9. The system according to claim 1, wherein
the stock information transmitted from the store server to the information terminal includes merchandise information on each merchandise item in stock, and
the information terminal includes
a second storage unit that stores the merchandise information on each merchandise item in stock, which is included in the stock information received by the communication unit, and
a display control unit configured to display the merchandise information on at least one candidate merchandise item selected from among the stored merchandise displayed on the display unit.

10. A store server comprising:
a merchandise database that stores merchandise information on each merchandise item in a store;
when it is possible to exchange information with the information terminal carried by a shopper in the store, an acquisition unit is configured to acquire from the information terminal or a Web server purchase-planned item information indicating an item of merchandise that the shopper wants to purchase, the information terminal configured to allow the shopper to select items of the purchase-planned item information based on a detected position of the shopper within the store and a position of the merchandise items within the store being a same position;
a check unit configured to search the merchandise database based on the purchase-planned item information and to check stock of an item of merchandise that the shopper wants to purchase; and
a transmission unit configured to transmit stock information, including stock availability indicating whether the item of merchandise that the shopper wants to purchase is in stock, to the information terminal.

11. The server according to claim 10, wherein
the store server is further configured to transmit to the information terminal merchandise information on at least one candidate merchandise item selected from among merchandise of the corresponding item in stock, and to cause the merchandise information to be displayed on a display unit of the information terminal.

12. A display control method of a computer of an information terminal that includes a storage unit configured to store information, a communication unit configured to communicate with an external device and a display unit configured to display information, and the information terminal is capable of being carried by a shopper in a store, the method comprising:
receiving stock information on merchandise corresponding to an item that the shopper wants to purchase, which is determined based on purchase-planned item information indicating an item of merchandise that the shopper wants to purchase, and the shopper presets the item of merchandise that the shopper wants to purchase from a store server configured to manage a merchandise database that stores merchandise information on each merchandise item available in the store by the communication unit,
allowing the shopper to select items of the purchase-planned item information based on a detected position of the shopper within the store and a position of the merchandise item within the store being the same; and
displaying stock availability of the merchandise corresponding to the item that the shopper wants to purchase on the display unit, based on the stock information transmitted from the store server.

13. The system according to claim 1, wherein the position detector is arranged to detect a position of the information terminal within the store based on a coordinate map in the store.

14. The system according to claim 1, wherein the display unit of the information terminal is configured to automatically display a merchandise information screen for receiving a shopper selection of an item of the purchase-planned item information when the detected position of the information terminal is a same position as that of the item of merchandise that the shopper wants to purchase.

15. The server according to claim 10, configured such that the display unit of the information terminal automatically displays a merchandise information screen, transmitted from the server, for receiving a shopper selection of an item of the purchase-planned item information, received from the server, when the detected position, received from the server, of the information terminal is a same position as that of the item of merchandise that the shopper wants to purchase.
